(19) United States
(12) Patent Application Publication
(10) Pub. No.: US 2007/0298866 A1
(43) Pub. Date: Dec. 27, 2007

(54) METHODS AND SYSTEMS FOR INTERACTIVE CUSTOMIZATION OF AVATARS AND OTHER ANIMATE OR INANIMATE ITEMS IN VIDEO GAMES

(76) Inventors: Paolo Gaudiano, Essex, MA (US); Eric Bonabeau, Winchester, MA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/768,460

(22) Filed: Jun. 26, 2007

Related U.S. Application Data
(60) Provisional application No. 60/805,809, filed on Jun. 26, 2006.

(51) Int. Cl. A63F 13/00

(52) U.S. Cl. 463/23

(57) ABSTRACT

Methods and systems enable users of video games to interactively adjust the characteristics of a customizable game items, such as avatars or any animate or inanimate items. Users are presented with a plurality of items through a user interface employing an interactive configuration process. Each item may correspond to one particular configuration of the customizable game item. The user is enabled to assign a subjective value to any of the items, corresponding for example to the user's likes or dislikes. The methods and systems then may identify a new set of items that take into account the subjective evaluation and may present them to the user through the user interface. The user again is enabled to assign a subjective value to any of the items, and the process may be repeated. Thus, the disclosed methods and systems may generate a customized game item that is increasingly satisfactory to the user.

### REFERENCE TO RELATED APPLICATIONS

The present application claims the benefit under 35 U.S.C. §119(e) of U.S. Provisional Patent Application Ser. No. 60/805,809, filed on Jun. 26, 2006, entitled “Methods and Systems for Interactive Customization Of Avatars And Other Animate Or Inanimate Items In Video Games”, which is hereby incorporated herein by reference.

### BACKGROUND OF THE INVENTION

1. Field

The disclosed invention relates to a method and system that enables the user of a video game to adjust the characteristics of a customizable game item, such as an avatar or any animate or inanimate item. The method and system enables users to adjust customizable game items to their liking in a pleasing, interactive and fast way.

2. Description of Art

Video games, including many played on computers, on specialized gaming hardware, or online through the Internet, may allow the user to customize items such as “avatars” (simulated persons) or other animate and inanimate objects. Methods known in the art may provide video game users with the ability to set one or more characteristics of the “customizable game items.” For example, games that have human, animal, alien, or any other simulated living organism may allow the user to change many characteristics of the avatar. These characteristics may include: gender, body type, hair type/color, skin tone, facial features, clothing, accessories, weapons, skills, behavioral traits and tendencies, and so on.

Some games include vehicles as customizable game items. This may include cars, trucks, motorcycles, airplanes, boats, helicopters, spaceships or other vehicles. The customizable characteristics may include size, shape, paint, decals, body parts (spoilers, wheels, mirrors, glass, doors, grilles, bumpers, wings, hulls, . . . ), engine parts, or performance characteristics (handling, speed, acceleration, braking, . . . ).

Other customizable game items may include animals, monsters, aliens, vegetation, buildings and other architectural elements, roadways, terrain, landscaping, weapons, clothing, and many more.

In some video game implementations, the user may be given a set of items that can be customized, and a means of modifying the characteristics of these customizable game items through a user interface, which may include buttons, sliders, text boxes, check boxes, radio buttons, pull-down menus, tabs, scrollbars, and other such means known in the art of setting the value of each characteristic.

In such video games, the set of customizable characteristics and their values may be combined to yield large numbers of possible custom configurations for each customizable game item. A number of possible custom configurations for a customizable game item may be calculated in some circumstances by multiplying together, for all customizable characteristics, the number of configuration values that each characteristic can take. For example, a game that allows the user to independently customize five (5) characteristics of an item, where each characteristic can have just three (3) distinct values, can generate 3*3*3*3*3 or 243 distinct variants of the item. A game with five (5) independent characteristics, which can have respectively 3, 4, 5, 6 and 7 values, can generate 3*4*5*6*7 or 2,520 distinct variants of the item.

Video games today may allow dozens of characteristics to be characterized with dozens or hundreds of values. A single customizable game item in a game may have millions or even billions of possible configurations.

As an example, the on-line game Second Life® (www.secondlife.com) enables users to customize an avatar. The web site description of Second Life boasts the ability to offer “almost infinite possibilities” in the customization of avatars. In the current version, the user can modify shape, skin, hair, eyes, shirt, pants, shoes, socks, jacket, gloves, undershirt, underpants, and skirt. The “shape” tab alone allows customization of body, head, eyes, ears, nose, mouth, chin, torso, legs and gender. Each of these tabs in turn allow the user to set a value between 0 and 100 for several characteristics. For instance, under “body” the user can set body height, body thickness and body fatness, while under “eyes” the user can set eleven (11) distinct parameters. Even if we only consider the two most extreme values (0 and 100) for each characteristic, the “shape” tab alone could be used to generate 279 distinct avatars. If one were to try each possible avatar, doing one avatar per second would take about 2×10¹⁶ years.

As another example, a recent version of the video game Need for Speed Underground® (by EA Games) allows the user to customize the appearance and performance of over a dozen cars. For the visual appearance of each car, the user has to navigate a hierarchical menu system in order to specify body kits (about 10), spoilers (about 60), wheel rims (about 50), hoods (about 30), roof scoops (about 60), paint type/color (about 200), vinyl (about 150), rim paint (about 60), window tinting (about 30), decals (about 100 at each of 30 distinct positions), numbers (about 100), gauge style/color (about 240). Hence any single car can be customized in approximately 200,000,000,000,000,000,000,000 (2×10²³) distinct ways. This does not include a comparable number of performance customizations.

The vast customization capability of these games, however, may create difficulties for the user. Selecting a configuration may require the user to navigate through dozens of menus, tabs, buttons, sliders, and other interface elements. Because there are so many characteristics to configure, the task of finding a “really good” configuration may be very time consuming and frustrating. The user may only ever be able to explore a minute fraction of all the possible configurations. In the Second Life® example above, consider the following: if they had one billion users generating one distinct avatar simply by changing the “shape” tab characteristics (i.e., no clothing or accessories), selecting only the values 0 or 100 for each characteristic, and if each user could create one such avatar per second and worked 24 hours a day non-stop, it would take approximately 2×10¹²³ years to explore just 1% of all possible avatars.

Hence by offering so many customization options, the game actually may make it extremely difficult for the user to really find what he or she is looking for.

Furthermore, because the search space may be so vast, there may be some specific configurations that the user may find very appealing, but that the user may never actually encounter. The process of selecting characteristics sequentially may be especially ill-suited to searching alternate configurations, because each time the user chooses one value for one characteristic, all subsequent choices may be constrained to a subset of the initial configuration space. This process of “elimination” may make it extremely difficult to compare two or more configurations that are significantly different from each other.

In summary, games that offer significant customization capabilities may create two problems for their users. First, the process of customizing game items may be very tedious and time consuming. Second, it may be virtually impossible for a user to explore even a minute fraction of the possible configurations for ay customizable game item.

As an alternative approach to customization, in some video games the user may not have the ability to customize individual characteristics, and may instead be presented with a plurality of pre-configured items from which the user may select one. For example, a video game may give the user the choice of one among a plurality of avatars, one among a plurality of vehicles, one among a plurality of weapons, and so on. This may reduce dramatically the user's ability to customize his or her experience.

Some other video games take an intermediate approach. The online game Neopets®, for instance, allows the user to select one of 53 distinct species. Once a species is selected, the user can set six (6) characteristics, for a total of 3,072 configurations. Hence it is possible to create approximately 163,000 distinct pets.

In these cases, while the users may create a customized game item relatively quickly, the resulting selection may not be unique. For instance, the Neopets® web site indicates that, as of April 2006, over 170 million pets have been created. This means that on average, there are over 1,000 identical copies of each possible pet.

What is needed is a method and system to provide the user with vast customization capabilities, while making the search process simpler, more interactive, less time consuming and less frustrating.

### SUMMARY

The disclosed methods and systems for interactive customization enable a video game user to select a custom configuration for any avatar, animate character or inanimate object (henceforth “customizable game item”) in a highly interactive, simple and intuitive fashion.

The disclosed methods and systems employ an interactive configuration process that begins by presenting the user with a plurality of items through a user interface. Each item may correspond to one particular configuration of the customizable game item. The user is enabled to assign a subjective value to any of the items, corresponding for example to the degree to which the user may like or dislike that configuration of the customizable game item. The interactive customization methods and systems then may identify a new set of items that take into account the subjective evaluation of the user, and may present the new items to the user through the user interface. The user again is enabled to assign a subjective value to any of the items, and the process may be repeated. As this interactive customization process continues, the disclosed methods and systems may generate a customized game item that is increasingly satisfactory to the user.

The disclosed methods and systems may include algorithms to generate random configurations that may enable the user to search widely diverse configurations of the customizable game item. This may enable the user to search a much broader set of options than may be feasible through existing customization methods.

The disclosed method may further include algorithms to constrain the number of allowable configurations presented to the user by discarding highly undesirable configurations.

The disclosed methods and systems may further include algorithms that adapt the search process as a result of user interaction, effectively “learning” each user's preferences to expedite the search process.

The disclosed methods and systems may include means to enable the user to “freeze” certain aspects of the configuration, to restrict the interactive customization to a subset of the space of all possible configurations.

The disclosed methods and systems may include means to enable the user to switch between traditional and interactive methods of customization.

The disclosed methods and systems may include means to allow the user to backtrack through the steps of interactive customization.

The disclosed methods and systems may include means to allow the user to “fork” along multiple search paths.

The disclosed methods and systems may include means to allow the user to save multiple instances of the customizable game item, each instance consisting of a particular configuration.

The disclosed methods and systems may include means to allow the user to save the specific configuration settings selected during the customization, so that the same configuration may later be applied to the same or another customizable game item.

### BRIEF DESCRIPTION OF THE DRAWINGS

FIG. 1a is an illustration of an embodiment of an interactive user interface for creating a customized item within a video game;

FIG. 1b is a further illustration of the embodiment of FIG. 1a; and

FIG. 2 is an illustration of another embodiment of an interactive user interface for creating a customized item within a video game.

### DESCRIPTION OF CERTAIN EMBODIMENT(S)

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the spirit and scope of the systems and methods described herein.

Unless otherwise specified, the illustrated embodiments should be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without departing from the disclosed systems or methods.

The methods and systems set forth herein may provide a way of simplifying and enhancing the process of creating a customized item within a video game. The methods and systems differ from prior methods and systems of customization which require the user to set the value of one or more characteristics manually, through a graphical user interface or through a parameter file.

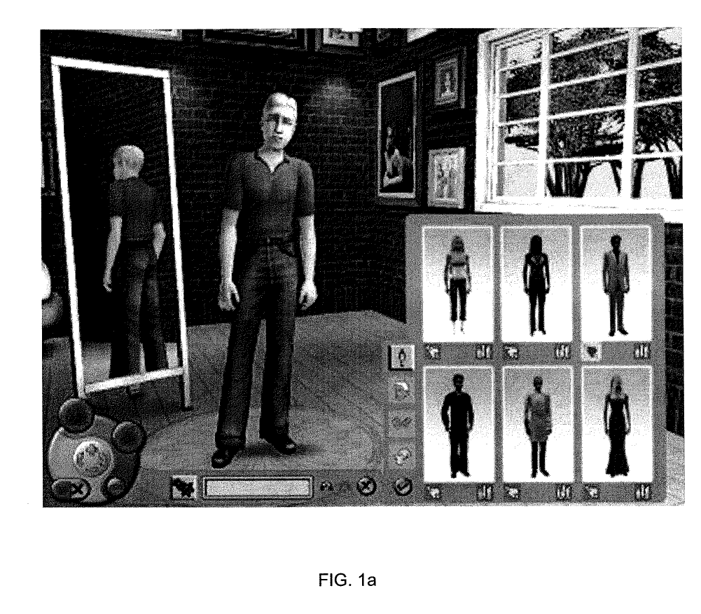

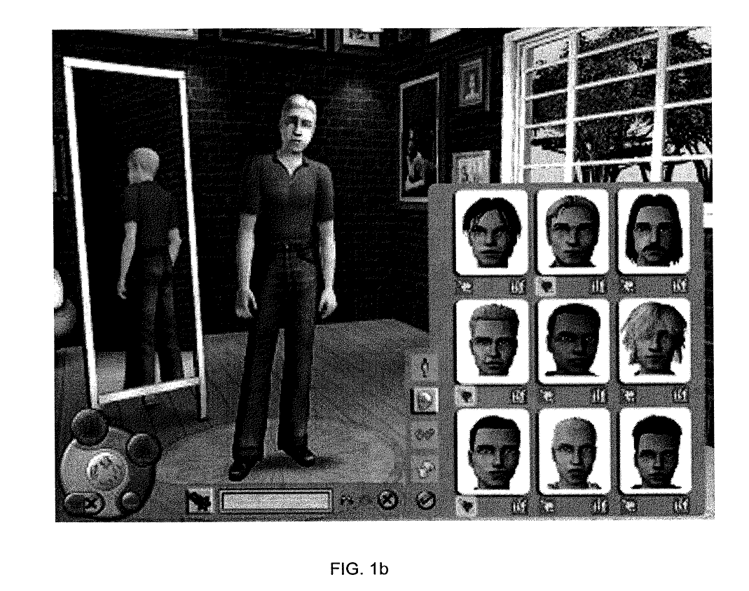

One embodiment of the invention is illustrated in overview in FIG. 1. In this embodiment the user may wish to customize an avatar. It will be obvious to those skilled in the art that the same methods can be used for any customizable game item, such as a vehicle, building or equipment.

In the embodiment described in FIG. 1 the user may initially be presented with a set of avatars. The initial set of avatars may be selected from a previously defined set of “default” avatars, they may be created randomly, or they may be created based on some prior general input from the user. In this embodiment the initial set of avatars may be in a 3×2 grid, or a 3×3 grid, but other configurations are possible, both in terms of the layout and in terms of the number of avatars being displayed.

This embodiment of the invention may allow the user to create new avatars in two different fashions: mutation of a single avatar, or crossover between two or more avatars. Other methods for creating avatars based on the user selection can be easily envisioned by those skilled in the art.

For mutation, the user may select one of the avatars in the display (for example by clicking the mouse over that avatar). A new set of avatars may be derived from the selected avatar using any algorithm that is able to modify the avatar's characteristics so as to generate similar avatars. This may include random modification of individual parameters, or more advanced algorithms familiar to those skilled in the art, such as genetic algorithms or other search algorithms.

For crossover, the user may select two or more avatars. This embodiment may create a new set of avatars by combining the characteristics of the avatars selected by the user. Crossover may be effected through a number of methods, such as linear or nonlinear averaging, interpolation, genetic algorithms, vector summation, or other algorithms familiar to those skilled in the art.

This embodiment may further allow the user to create a new set of avatars through a mixture of mutation and crossover, or other methods.

Alternatively or additionally, this embodiment may allow the user to assign a value or a ranking to avatars, by expressing a relative preference. For example, a slider or checkbox system may be associated with each avatar and may be used by the user to express the degree of satisfaction or dissatisfaction with that particular avatar. These preferences may be used by the embodiment to guide the mutation or crossover operations toward generating a new set of avatars that may be increasingly satisfying to the user. For example, the embodiment may suppress the probability of choosing avatars with configurations that are similar to the configurations as to which the user has expressed dissatisfaction.

Once a new set of avatars has been created through a process of mutation and/or crossover, the embodiment may allow the user to repeat the cycle by making additional selections and/or rankings to generate a new set of avatars. We refer to one such cycle as one “generation.”

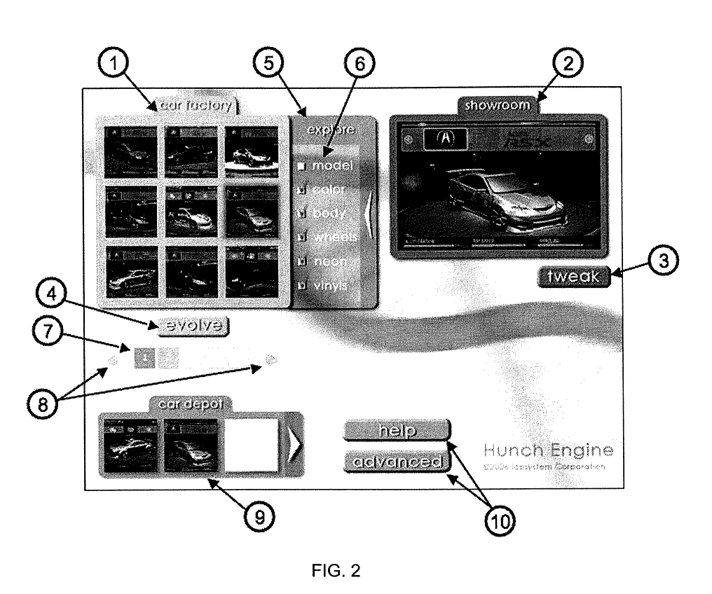

A further embodiment of the invention is described in overview in FIG. 2. In this embodiment the user may wish to customize an item such as a car found in the game Need for Speed Underground®. In this circumstance the user may be presented with a plurality of cars, each customized with a particular set of configuration options, as shown in the “Car Factory” 1. Hovering the mouse over any of the thumbnail images within the Car Factory or alternatively, clicking on a single image, may causes a larger image of that car to be visualized in the “Showroom” 2. Below the showroom, a “Tweak” button 3 may enable the user to switch to a manual mode where individual parameters may be set, as is done with prior game customization.

In order to visualize the next generation of cars, the user may select one or more of the thumbnails in the Car Factory 1, for example through double-clicking or right-clicking the thumbnail(s) of one or more cars the user finds satisfactory. Alternatively or additionally, the embodiment may enable the user to indicate cars that are particularly unsatisfactory. Once one or more cars are selected in this fashion, clicking the “Evolve” button 4 may cause the invention to generate a new set of cars, whose characteristics are adjusted to reflect the user preferences. If the Evolve button 4 is pressed with no cars selected, the invention may generate an entirely new set of cars.

In the embodiment of FIG. 2 the invention may include an “Explore” panel 5 which may enable the user to specify that only certain characteristics of the selected cars should be modified by the invention. In the example shown, the user has unchecked the box for “model” 6, which means that all cars presented in the next set will be of the same model as the selected car. Other characteristics, including color, body, wheels, and so on, may differ between different cars in the set.

In the embodiment of FIG. 2, as the user progresses through the search, a small panel representing the “History” of searches 7 may show the user how many cycles or generations have taken place. The user may also move backward and forward through the search History by clicking on the history panel, or by using navigation buttons 8. In other embodiments, the History panel may allow for branching, whereby the user might return to an earlier point in the search History and perform a new search from that point, without losing the prior search that originated from that point in the History.

In the embodiment of FIG. 2, a “Car Depot” 9 panel may enable the user to save one or more cars. Cars may be moved from the Showroom 2 or from the Car Factory 1 by drag-and-dropping or other similar means. The Car Depot may include navigation buttons to scroll through cars, when the number of cars in the Car Depot is large enough that not all cars can be conveniently visualized simultaneously.

In the embodiment of FIG. 2, additional buttons 10 may allow the user to access further functionality, such as a help menu, or to switch to a more advanced mode of customization.

For the embodiments of FIG. 1 and FIG. 2 or any other embodiment, during each generation the invention may allow the user to perform several optional actions that may facilitate the customization of the avatar or other customizable game item. Optional actions may include: viewing additional details of each avatar; storing any avatar for later use; loading avatars that were previously stored; restarting the entire process with an entirely new set of avatars; freezing certain characteristics of the avatar so that subsequent generations of avatars only vary in the other characteristics; backtracking to previous generations; creating multiple “branch points” from any generation to allow parallel searches; or any other optional actions that may enhance the user's ability to customize an avatar.

Various embodiments may maintain a level of randomness in the customization process, so as to continue presenting novel alternatives to the user. This may avoid the problem of the search becoming too narrow too quickly, and may allow the possibility that the user may see alternative desirable items.

Various embodiments may allow the user to select the degree of randomness in the customization, for example through a slider with the two extremes labeled “Guide me” and “Surprise me,” corresponding respectively to low and high randomness.

The interactive customization or search process based on user feedback may be implemented in various ways. In some embodiments, the search may be performed using Interactive Evolutionary Computing, as set forth in Methods And Systems For Interactive Evolutionary Computing (IEC), U.S. Pat. No. 7,043,463 to Bonabeau, et al., which is incorporated herein by reference as if fully set forth. In addition or alternately, search processes as set forth in Methods And Apparatus For Interactive Searching, U.S. patent application Ser. No. 11/176,968 to Bonabeau, et al. and in Methods And Apparatus For Interactive Searching Techniques, U.S. patent application Ser. No. 11/537,143 to Bonabeau, et al., which are both incorporated herein by reference as if fully set forth, may also be used.

In such embodiments, the characteristics of each item may be encoded as a genetic string. For example, a genetic string might be used to represent the customizable game item's characteristics. In the case of avatars, these might include gender, body shape, head shape, hair color, clothing, and so on. In the case of cars, genetically encoded characteristics might include car model, color, wheels, vinyls, and so on. Based on the user's feedback IEC may apply genetic operators to the strings representing all the items in the set to generate a new set of strings, corresponding to new customized items. The genetic operators may include selection, crossover, mutation, elitism and/or variants thereof.

The disclosed invention may use different methods for selection of new sets based on user feedback. Examples include neural networks, K-nearest neighbors, or other classification algorithms, machine learning algorithms, pattern recognition algorithms, or any other suitable algorithms familiar to those skilled in the art.

As used herein, a “user interface” is an interface between a human user and a computer that enables communication between the user and the computer. A user interface may include an auditory indicator such as a speaker, and/or a graphical user interface (GUI) including one or more displays. A user interface also may include one or more selection devices including a mouse, a keyboard, a keypad, a track ball, a microphone, a touch screen, a game controller (e.g., a joystick), etc., or any combinations thereof.

The various methods, acts thereof, and various embodiments and variations of these methods and acts, individually or in combination, may be defined by computer-readable signals tangibly embodied on one or more computer-readable media, for example, non-volatile recording media, integrated circuit memory elements, or a combination thereof. Such signals may define instructions, for example, as part of one or more programs, that, as a result of being executed by a computer, instruct the computer to perform one or more of the methods or acts described herein, and/or various embodiments, variations and combination thereof. Such instructions may be written in any of a plurality of programming languages or using any of a plurality of programming techniques.

For example, various methods according to the present disclosure may be programmed using an object-oriented programming language. Alternatively, functional, scripting, and/or logical programming languages may be used. Various aspects of the disclosure may be implemented in a non-programmed environment (e.g., documents created in HTML, XML or other format that, when viewed in a window of a browser program, render aspects of a graphical-user interface (GUI) or perform other functions). Various aspects of the disclosure may be implemented as programmed or non-programmed elements, or combinations thereof.

A given computer-readable medium may be transportable such that the instructions stored thereon can be loaded onto any computer system resource to implement various aspects of the present disclosure. In addition, it should be appreciated that the instructions stored on the computer-readable medium are not limited to instructions embodied as part of an application program running on a host computer. Rather, the instructions may be embodied as any type of computer code (e.g., software or microcode) that can be employed to program a processor to implement various aspects of the present disclosure.

Having thus described several illustrative embodiments, it is to be appreciated that various alterations, modifications, and improvements will readily occur to those skilled in the art. Such alterations, modifications, and improvements are intended to be part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Accordingly, the foregoing description and attached drawings are by way of example only, and are not intended to be limiting.

The methods and systems described herein are not limited to a particular hardware or software configuration, and may find applicability in many computing or processing environments. For example, the algorithms described herein can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) is preferably implemented using one or more high level procedural or object-oriented programming languages to communicate with a computer system; however, the program(s) can be implemented in assembly or machine language, if desired. The language can be compiled or interpreted.

As provided herein, the processor(s) can thus be embedded in one or more devices that can be operated independently or together in a networked environment, where the network can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a processor” or “the processor” can be understood to include one or more processors that can communicate in a stand-alone and/or a distributed environment(s), and can thus can be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network using a variety of communications protocols, and unless otherwise specified, can be arranged to include a combination of external and internal memory devices, where such memory can be contiguous and/or partitioned based on the application. Accordingly, references to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, can include one or more intranets and/or the internet.

Although the methods and systems have been described relative to specific embodiments thereof, they are not so limited. Obviously many modifications and variations may become apparent in light of the above teachings. In additional embodiments the items being customized might include, without limitation, any of the following: avatars, vehicles, weapons, buildings, plots, clothing, accessories, decorations, monsters, animals. The above are meant as partial lists, as the embodiment could work with any search in which the results come from a potentially vast set of choices.

Many additional changes in the details, materials, and arrangement of parts, herein described and illustrated, can be made by those skilled in the art.

What is claimed is:

1. A method for interactive customization of a computer generated item, comprising:
presenting a set of computer generated items to a user;
receiving feedback from the user;
creating a new set of computer generated items based on the feedback; and
iteratively presenting a set of computer generated items, receiving feedback and creating a new set of computer generated items until the feedback indicates user selection of an item from the set of computer generated items.

2. The method of claim 1, wherein presenting a set of computer generated items comprises presenting an initial set of computer generated items based on one of a default set of computer generated items, a randomly selected set of computer generated items, and prior input from the user.

3. The method of claim 2, wherein presenting an initial set based on prior input comprises:
receiving input from the user expressing relative preferences for the items in a prior set of computer generated items;
relating the relative preferences to characteristics of the computer generated items in the prior set;
storing a record of the related relative preferences and characteristics; and
presenting the initial set of computer generated items to the user based on the record.

4. The method of claim 2, wherein presenting an initial set based on prior input comprises:
receiving user input to save at least one instance of a computer generated item from a previous set of computer generated items; and
presenting the initial set of computer generated items based on applying characteristics of a saved instance of a previous set of computer generated items.

5. The method of claim 1, wherein receiving feedback comprises receiving input from a user designating at least one item of the set of computer generated items for customization.

6. The method of claim 5, wherein creating comprises modifying characteristics of the at least one item.

7. The method of claim 6, wherein modifying comprises applying a genetic algorithm to parameters of the characteristics.

8. The method of claim 7, wherein creating further comprises combining characteristics of at least two items.

9. The method of claim 8, wherein combining comprises at least one of linear averaging of parameters, nonlinear averaging of parameters, interpolation between parameters and vector summation of parameters.

10. The method of claim 5, wherein creating comprises combining characteristics of at least two items based on one of applying a genetic algorithm to parameters of the characteristics, linear averaging of parameters, nonlinear averaging of parameters, interpolation between parameters and vector summation of parameters.

11. The method of claim 1, wherein receiving feedback comprises receiving input from the user expressing relative preferences for items in the set of computer generated items.

12. The method of claim 11, wherein creating comprises modifying characteristics of the items in the set by applying genetic algorithms to parameters of the characteristics based on the relative preference.

13. The method of claim 11, wherein creating comprises suppressing a selection of characteristics of items, wherein the characteristics being suppressed are those of an item for which the input received from the user expressed dissatisfaction.

14. The method of claim 11, further comprising:
relating the relative preferences to characteristics of the computer generated items;
storing a record of related preferences and characteristics for the user; and
presenting a next initial set of computer generated items to the user based on the record.

15. The method of claim 11, wherein creating comprises restricting interactive customization to a subset of all possible configurations of the computer generated items based on the relative preferences.

16. The method of claim 1, further comprising:
maintaining a record of the set of computer generated items for each iteration; and
presenting a previous set of computer generated items based on a user request.

17. The method of claim 16, wherein maintaining a record comprises maintaining a record of multiple iterative paths.

18. The method of claim 1, wherein receiving feedback comprises receiving user input to save at least one instance of a computer generated item from the set of computer generated items.

19. The method of claim 18, wherein presenting a set of computer generated items comprises presenting an initial set of computer generated items based on applying characteristics of a saved instance of a previous set of computer generated items.

20. A method for interactive customization of characteristics of a computer generated game item, comprising:
presenting a set of computer generated game items to a user;
receiving feedback from the user regarding characteristics of the items;
modifying the characteristics of the computer generated game items based on the feedback to create a new set of computer generated game items having the modified characteristics; and
iteratively presenting the new set of computer generated game items, receiving feedback and modifying the characteristics until the feedback indicates user selection of an item from the new set of computer generated items.

21. The method of claim 20, wherein modifying comprises applying genetic algorithms to characteristics of one computer generated game item of the set of computer generated game items, wherein the feedback comprises a selection of the one computer generated game item by the user.

22. The method of claim 20, wherein modifying comprises combining characteristics a plurality of computer generated game items from the set of computer generated game items, wherein the feedback comprises selection of the plurality of computer generated game items by the user.

23. The method of claim 22, wherein modifying further comprises applying genetic algorithms to characteristics of at least one of the plurality of computer generated game items.

24. The method of claim 22, wherein modifying comprises applying genetic algorithms to characteristics of the plurality of computer generated game items, wherein the feedback comprises values assigned by the user expressing a relative preference for each of the plurality of computer generated game items.

25. The method of claim 24, wherein:
the value assigned by the user for at least one of the computer generated game items expresses dissatisfaction; and
modifying comprises suppressing selection of computer generated game items having characteristics similar to characteristics of the at least computer generated game item for inclusion in the new set of computer generated game items.

26. A computer-readable medium having computer-readable signals stored thereon that define instructions for enabling a computer to customize characteristics of a computer generated game item, the instructions controlling the computer to:
present a set of computer generated game items to a user;
receive feedback from the user regarding characteristics of the items;
modify the characteristics of the computer generated game items based on the feedback to create a new set of computer generated game items having the modified characteristics; and
iteratively present the new set of computer generated game items, receive feedback and modify the characteristics until the feedback indicates a final user selection of an item from the new set of computer generated items.

27. The computer-readable medium of claim 26, wherein the instructions controlling the computer to present comprise instructions controlling the computer to present an initial set of computer generated game items based on applying a genetic algorithm to characteristics of at least one previous final user selection.

28. The computer-readable medium of claim 27, wherein the instructions controlling the computer to modify comprise instructions controlling the computer to apply genetic algorithms to characteristics of at least one of the set of computer generated game items.

29. The computer-readable medium of claim 28, wherein:
the instructions controlling the computer to receive feedback comprise instructions controlling the computer to receive values assigned by the user expressing a relative preference for each of the plurality of computer generated game items; and
the instructions controlling the computer to modify comprise instructions controlling the computer to apply genetic algorithms to characteristics of the plurality of computer generated game items based on the values assigned.

30. A computer system enabling customization of characteristics of a computer generated game item, comprising:
a display for presenting a set of computer generated game items to a user;
a selection device for enabling the user to provide feedback regarding characteristics of the items;
a processor for modifying the characteristics of the computer generated game items based on the feedback to create a new set of computer generated game items having the modified characteristics, wherein the system iteratively presents the new set of computer generated game items, receives feedback and modifies the characteristics until the feedback indicates a final user selection of an item from the new set of computer generated items.

31. The computer system of claim 30, wherein the processor applies a genetic algorithm for modifying the characteristics.
